(19) United States
(12) Patent Application Publication
(10) Pub. No.: US 2026/0063369 A1
(43) Pub. Date: Mar. 5, 2026

(54) GROUND COMPACTION MACHINE AND METHOD FOR OPERATING A GROUND COMPACTION MACHINE

(71) Applicant: BOMAG GMBH, Boppard (DE)

(72) Inventors: Jost BECKER, Boppard (DE); Raphael ZOHNER, Boppard (DE); Dominik SCHMIDT, Boppard (DE)

(21) Appl. No.: 19/307,546

(22) Filed: Aug. 22, 2025

(30) Foreign Application Priority Data
Aug. 27, 2024 (DE) 10 2024 124 436.4

(51) Int. Cl. F28C 3/04; B06B 1/16; E01C 19/26; E01C 19/40; E01C 21/00; E02D 3/046; F16F 15/08; H02K 7/06

(52) U.S. Cl. CPC F28C 3/04; B06B 1/167; E01C 19/26; E01C 19/402; E01C 21/00; H02K 7/061; E02D 3/046; F16F 15/08

(57) ABSTRACT

A ground compaction machine with a machine frame, a ground contacting device mounted movably on the machine frame, a vibration excitation device and an electrical operating component comprising a housing. A method for operating a ground compaction machine. A heat exchanger fluid tank is provided with which a conductive heat exchange takes place between the electrical operating component and a heat exchanger fluid stored in a storage space of the heat exchanger fluid tank.

### FIELD

The invention relates to a ground compaction machine and a method for operating a ground compaction machine.

### BACKGROUND

Ground compaction machines are machines that are used to compact the ground, for example in road, path and route construction and other construction projects where a compacted ground is required. Such ground compaction machines typically have a ground contacting element that stands on the ground surface and/or moves over it, thereby exerting a static and/or dynamic force on the ground for compaction purposes. Such ground compaction machines can be operated manually, remotely and/or from an operator platform by an operator traveling on the ground compaction machine.

Ground compaction machines that are conventionally driven by an internal combustion engine are known. However, the emission load for the operator and/or the environment associated with the operation of a combustion engine is increasingly perceived as disadvantageous and/or limited by legal regulations. To meet these requirements, it is already known to equip ground compaction machines with a hybrid or all-electric drive system. In order to provide the electrical energy required for the electrical operation of such a ground compaction machine, it is also already known to connect these ground compaction machines to an electrical energy source with a cable and/or to equip them with an energy storage module, in particular in the form of a rechargeable battery or accumulator, which is carried along by the ground compaction machine during operation and can also be replaceable, for example. When operating a ground compaction machine using electrical energy, however, the electrical operating components can be exposed to considerable temperature loads. Such electrical operating components can, in particular, be one or more electrical energy storage devices, power converters and/or electric motors. In this context, it is known to cool the exchangeable electrical energy storage device of an electrical drive system in a ground compaction machine in the form of a rammer by means of a cooling air flow generated by a fan. This is disclosed, for example, in DE 10 2010 055 632 A1. However, such air cooling systems can also be disadvantageous, as they are comparatively complex in design, consume additional electrical energy and can considerably complicate the processes to be controlled in such a ground compaction machine.

### SUMMARY

Based on this, it is an object of the invention to provide a way of simplifying the operation of one or more electrical operating components of a ground compaction machine.

The object is achieved with a ground compaction machine and a method according to the independent claims. Preferred embodiments are cited in the dependent claims.

A ground compaction machine according to the invention comprises a machine frame, a ground contacting device mounted movably on the machine frame, a vibration excitation device which sets the ground contacting device into a vibrating and/or tamping motion in a compaction operation, and an electrical operating component comprising a housing.

In particular, the machine frame may be a support structure on which components of the ground compaction machine can be mounted, in particular, for example, the ground contacting device and/or one or more electric motors and/or one or more electrical operating components and/or a manual guide device. The machine frame may be configured as a so-called superstructure, on which a substructure comprising the ground contacting device is movably mounted. If the ground compaction machine is a hand-guided ground compaction machine, a manual guide device, such as in particular a guide bracket or a guide drawbar, may be hinged to the machine frame, usually via suitable vibration damping elements.

The ground contacting device is the unit of the ground compaction machine that is, at least temporarily, in direct contact with the ground surface during the ground compaction process and when the ground compaction machine is used as intended. The ground contacting element can roll over the ground to be compacted, as is the case with roller drums, for example, or move over the ground surface by tamping and/or bouncing, as is the case with a ground contacting element in the form of a tamping foot of a vibratory rammer and with a ground contacting element in the form of a base plate or tamping plate of a vibratory plate compactor, for example. The ground contacting element may be connected to the machine frame of the ground compaction machine via one or more vibration damping elements.

The vibration excitation device may be a device that sets the ground contacting element in a vibrating and/or tamping motion relative to the machine frame. Such device may be, for example, one or more imbalance exciters, in particular for ground compaction machines of the roller and vibratory plate compactor type, or may be a crank drive, in particular for ground compaction machines of the vibratory rammer type. The vibration excitation device may also have multiple individual vibration excitation devices at the same time, which may be operated in a coordinated manner in their vibration behavior, in particular relative to each other, for example to achieve different compaction effects of the ground compaction machine and/or to influence a driven machine movement.

The ground compaction machine may comprise one or more electrical operating components. Electrical operating components herein refer in particular to those components of the ground compaction machine that supply, convert and/or consume electrical energy during operation of the ground compaction machine and generate heat in the process. In particular, the invention relates to such electrical operating components that are integrated into an electrical drive train, starting from a primary electrical energy source, such as a battery, up to a traction drive and/or drive of a vibration excitation device. The heat generated during operation of the electrical operating components may affect the operational reliability of the ground compaction machine, the range and/or the service life of the respective electrical operating component.

Specifically, the electrical operating component may, for example, be an electrical energy storage device with one or more energy storage elements or cells, such as a battery and/or an accumulator. In particular, the electrical energy storage device may be configured as a replaceable energy storage module, especially one that can be replaced without tools. Such replaceable energy storage modules are used, for example, when the energy storage module needs to be able to be changed frequently, such as when using rechargeable batteries. Heat may be generated when discharging and charging the electrical energy storage device.

Additionally or alternatively, the electrical operating component may also be one or more power converters. Such a power converter can also be referred to as power electronics. A power converter converts one type of incoming current into another type of outgoing current, for example direct current drawn from an electrical energy storage device into alternating current, in particular a three-phase current. The power converter can also heat up during this conversion.

Additionally or alternatively, the electrical operating component may further be an electric motor. An electric motor converts incoming electrical energy into mechanical energy and may herein be used in particular to drive one or more vibration excitation devices and/or a traction drive. In particular, the electric motor may be a direct current motor or an alternating current motor, especially a three-phase motor. In particular, the electric motor may be a brushless DC (BLDC) motor.

The ground compaction machine may have one or more of the electrical operating components at the same time. It may also have multiple similar electrical operating components at the same time, in particular multiple electrical energy storage devices and/or multiple electric motors.

The electrical operating component may have a housing. The housing may form the outer surface of the electrical operating component and at the same time provide a protective function for functional components of the respective electrical operating component which are arranged inside the housing. In particular, the electrical operating component may be configured such that it meets a protection level of preferably IP67 in accordance with DIN EN 60529:2014-09. In particular, this can mean that the housing of the electrical operating component is configured to be dust-tight, and that the housing provides complete protection against contact and protection against temporary submersion.

According to the invention, the ground compaction machine may in particular comprise a heat exchanger fluid tank. The heat exchanger fluid tank thus refers to a device that is configured to hold and store a heat exchanger fluid. For this purpose, the heat exchanger fluid tank comprises at least, and in particular only, one storage space that is filled with a heat exchanger fluid. This does not mean that the storage space must be filled to the brim with a heat exchanger fluid. However, sufficient heat exchanger fluid should be available and stored in the storage space in order to fulfill the heat storage and/or release function described in more detail below. The storage space thus refers in particular to a hollow space in the heat exchanger fluid tank in which heat exchanger fluid is stored and can be carried along by the ground compaction machine during ground compaction operation.

The heat exchanger fluid stored in the storage space of the heat exchanger fluid tank is a liquid or a mixture of liquids. In particular, this can mean that the heat exchanger fluid may be a fluid that is in a liquid aggregate state at least in a temperature range greater than 0° C. to 60° C., particularly at least in a temperature range of −20° C. to 90° C. The heat exchanger fluid may, for example, be water, a water-glycol mixture, oil or another dielectric fluid and/or a mixture thereof. The heat exchanger fluid may also comprise one or more additives that have a melting point lowering and/or boiling point raising and/or biocidal effect.

The ground compaction machine according to the invention may further comprise a heat exchange surface within the heat exchanger fluid tank. The heat exchange between the electrical operating component and the heat exchanger fluid inside the storage space, which is described in more detail below, therefore takes place inside the heat exchanger fluid tank, in particular by means of a conductive heat transfer process via the heat exchange surface. It is therefore particularly intended that the heat exchange between the electrical operating component and the heat exchanger fluid takes place in the storage space of the heat exchanger fluid tank itself and that heat exchanger fluid is therefore not circulated within a complex cooling fluid circuit, in which it is removed from the heat exchanger fluid tank and fed back elsewhere, thereby exchanging heat with the electrical operating component outside the heat exchanger fluid tank. Even if the heat capacity inherent in the heat exchanger fluid results in a less efficient heat exchanger system than conventional cooling circuits, it has been shown that the achievable heat management effects can be sufficient for the specific application of the ground compaction machine according to the invention. In addition to conductive heat exchange processes, in which thermal energy is supplied to the electrical operating component from the heat exchanger fluid, the invention also includes, in particular, cooling processes for the electrical operating component, i.e., heat exchange processes in which thermal energy is withdrawn from the electrical operating component by the heat exchanger fluid via the heat exchanger surface. In the present case, the heat capacity of the heat exchanger fluid stored within the storage space of the heat exchanger fluid tank is therefore used as a cold and/or heat store to enable heat exchange, in particular for cooling purposes, with the electrical operating component.

The invention thus relates in particular to embodiments in which the electrical operating component and the heat exchanger fluid are in direct contact with each other via the heat exchanger surface. It may therefore also be preferred if the heat exchanger fluid tank has a receiving opening at the top in the vertical direction and the electrical operating component projects, at least partially, through the receiving opening into the storage space filled with heat exchanger fluid. The receiving opening thus refers in particular to such an opening of the heat exchanger fluid tank through which at least a part of the electrical operating component can be introduced into the interior space formed by the heat exchanger fluid tank or its tank walls. Ideally, the heat exchanger fluid tank may have a bottom wall and side walls adjoining the bottom wall in a vertical direction and protruding from the bottom wall. By providing the receiving opening at the top in the vertical direction, it is comparatively easy to ensure that no heat exchanger fluid leaks out of the storage space due to gravity when the electrical operating component is inserted into and removed from the interior space of the heat exchanger fluid tank.

It is possible that the heat exchanger fluid tank within the storage space has a contact membrane made of a flexible and fluid-tight material that forms at least part of the heat exchange surface. The contact membrane can mechanically separate a receiving space for the electrical operating component within the heat exchanger fluid tank from a storage space within the heat exchanger fluid tank that receives and stores the heat exchanger fluid. In this way, it can be achieved that the electrical operating component is not in direct contact with the heat exchanger fluid, but nevertheless a form-fitting and extensive contact is maintained between the electrical operating component and the contact membrane in order to enable at least almost exclusively conductive heat transfer via the housing of the electrical operating component and via the contact membrane to the heat exchanger fluid. The contact membrane may have a bag-like configuration and/or be fluid-tight with respect to the heat exchanger fluid. Additionally or alternatively, it may be arranged so as to surround the receiving opening, for example be welded and/or glued and/or clamped to the heat exchanger fluid tank in the region of the receiving opening.

However, it is particularly preferred if the housing of the electrical operating component is wet directly with the heat exchanger fluid inside the heat exchanger fluid tank or is in direct contact with it. The electrical operating component may thus be arranged relative to the heat exchanger fluid tank such that it is directly immersed in the heat exchanger fluid inside the storage space. In this case, only the housing of the electrical operating component, in particular the region of the housing of the electrical operating component wet by the heat exchanger fluid, forms the heat exchange surface via which heat is exchanged directly between the heat exchanger fluid inside the heat exchanger fluid tank and the electrical operating component. For this purpose, the heat exchanger fluid may wet the housing of the electrical operating component on at least one side, although it is preferred if the housing of the electrical operating component is wet by the heat exchanger fluid not only in the region of a bottom wall, but also simultaneously in the region of several side walls. It is particularly preferred if the electrical operating component is arranged relative to the heat exchanger fluid tank such that it is immersed in the heat exchanger fluid by more than 60%, particularly more than 80% of its total volume. It is possible that the electrical operating component is completely immersed in the heat exchanger fluid, except for any mounting devices and/or electrical energy transfer connections that may be provided, or that the housing of the electrical operating component is completely wet with heat exchanger fluid inside the heat exchanger fluid tank or its storage space. By directly wetting the electrical operating components with the heat exchanger fluid, a direct, at least partial, encapsulation of the electrical operating component with the heat exchanger fluid is achieved, which enables a particularly effective heat exchange between the electrical operating component and the heat exchanger fluid. The region of the housing of the electrical operating component that is wet by heat exchanger fluid when the ground compaction machine is used as intended is also referred to below as the wetting region. It will be appreciated that, depending on a current vibration load and/or orientation of the ground compaction machine, edge regions of the housing of the electrical operating component may be temporarily wet and temporarily unwet. Therefore, the wetting region herein refers in particular to that region of the outer surface of the housing of the electrical operating component which can be wet by heat exchanger fluid when used as intended, and when the ground compaction machine is used as intended.

In order to enable stable relative positioning of the electrical operating component and the storage space of the heat exchanger fluid tank, it is possible that, in particular within the storage space, one or more lateral guide elements are provided which are configured to align the electrical operating component relative to the heat exchanger fluid tank in a horizontal direction. These elements may, for example, be internals within the heat exchanger fluid tank that serve to fix the energy storage device relative to the heat exchanger fluid tank. Such lateral guide elements may, for example, be contact and/or guide webs or the like protruding from an inner wall and/or from a bottom wall of the heat exchanger fluid tank into the interior space towards the electrical operating component. These elements may, for example, be solid or hollow and open on one side to the outside of the heat exchanger fluid tank. It is possible that, viewed in the vertical direction of the electrical operating component, several levels of such lateral guide elements are provided and/or that these extend in the vertical direction over a substantial part of that region of the electrical operating component with which it projects into the storage space of the heat exchanger fluid tank. It is preferred if the contact surface formed by these lateral guide elements on the housing of the electrical operating components is less than 10%, in particular less than 5%, of the total outer surface of the electrical operating component that is wet by the heat exchanger fluid or lies in the wetting region. Additionally or alternatively, it is preferred if at least one such lateral guide element is provided on all of the opposing surfaces of the housing of the electrical operating component that protrude in the vertical direction within the heat exchanger fluid tank.

Additionally or alternatively, it may also be advantageous if, in particular within the storage space, one or more support elements are provided or, in particular, are included in the heat exchanger fluid tank, on which the electrical operating component stands within the heat exchanger fluid tank. These elements may, for example, be base-like elements that protrude vertically from a bottom of the heat exchanger fluid tank and on which the electrical operating component stands with a bottom region.

It is possible that the one or more lateral guide elements and the one or more support elements are combined, in particular such that wall regions on an outside of or adjoining one or more support elements vertically protrude beyond a support surface of the support elements and at least partially surround the housing of the electrical operating component in the lower side wall region.

One or more centering aids may also be part of the heat exchanger fluid tank. Centering aids herein refer in particular to mounting structures that have one or more inclined sliding surfaces along which the housing of the electrical operating component slides in the direction of a defined end position when it is inserted into the heat exchanger fluid tank.

In order to ensure that the electrical operating component is held in a stable position relative to the heat exchanger fluid tank, particularly during compaction operation and/or during transportation of the ground compaction machine, the ground compaction machine may have a fixing device that fixes the electrical operating component relative to the heat exchanger fluid tank. In particular, the fixing device may be detachable, especially in a non-destructive manner and without tools. It is ideal if the fixing device is configured such that, in a position fixing the electrical operating component, it simultaneously applies a retaining clamping force to it in the direction of the heat exchanger fluid tank. For example, the fixing device may have one or more tension fasteners and/or tension belts. It is also possible to use threaded connections and/or cam locks, for example.

It may be advantageous if the housing of the electrical operating component is configured such that it is not completely lowered into the storage space in its end position in the heat exchanger fluid tank. In order to achieve this, it is possible for the housing of the electrical operating component to have a contact collar that extends circumferentially, in particular in one plane, especially in a horizontal plane, and contacts the heat exchanger fluid tank and/or rests on the heat exchanger fluid tank. For this purpose, a contact structure complementary to the electrical operating component in the contact region may be included in the heat exchanger fluid tank, which the electrical operating component contacts in a form-fitting manner. A seal may also be provided in this contact region in particular, so that the electrical operating component simultaneously acts as a kind of lid sealing the storage space of the heat exchanger fluid tank towards the outside environment.

It may be advantageous if the distance between the outer surface of the housing of the electrical operating component and the inner surface of the heat exchanger fluid tank, in particular in a horizontal plane, is at least 5 mm, in particular at least 10 mm. This concerns at least the wetting region of the electrical operating component, i.e., the region of the electrical operating component that is wet by the heat exchanger fluid inside the heat exchanger fluid tank. The distances on the individual sides may be the same or different. Additionally or alternatively, it is also preferred if the bottom of the electrical operating component is at least 5 mm, in particular at least 10 mm, away from the bottom of the heat exchanger fluid tank when viewed vertically. Any contact points with one of the several lateral guide elements and/or support elements may be excluded from this.

Since the ground compaction machine according to the invention can be exposed to considerable vibrations, in particular during compaction operation, it is advantageous in practical use if one or more sealing elements are provided which seal the storage space of the heat exchanger fluid tank towards the outside environment, in particular in a sealing region between the heat exchanger fluid tank and the electrical operating component and/or between the heat exchanger fluid tank and a lid. This prevents heat exchanger fluid from spraying out of the storage space. Such sealing elements may be rubber or plastic seals, labyrinth seals and/or O-ring seals, for example.

The electrical operating component is a component that supplies and/or converts electrical energy during working operation of the ground compaction machine. In particular, it is a component of an electrical drive train of the ground compaction machine, in particular an electrical drive train running between an electrical energy storage device of the ground compaction machine and the vibration excitation device, the electrical energy storage device itself also being part of the electrical drive train. The electrical operating component may therefore comprise a connection terminal, in particular a non-destructively detachable connection port, for obtaining or establishing one or more current-conducting and/or signal-conducting connections. Particularly in the case of interchangeable components, such as an electrical energy storage device in the form of an interchangeable accumulator, it may be necessary to regularly disconnect and reconnect this connection port, for example in the form of a plug contact. In order to prevent heat exchanger fluid from entering the inner region of the connection port in this context, the connection port may be encapsulated in a fluid-tight manner. Additionally or alternatively, the connection port may also arranged on an upper side of the electrical operating component, in particular outside the wetting region and especially outside the storage space of the heat exchanger fluid tank. Additionally or alternatively, the connection port may also be arranged on a side of the electrical operating component that is located in a region of the electrical operating component that is not wet by the heat exchanger fluid. Additionally or alternatively, it may be advantageous if the connection port is positioned vertically above a sealing device that seals the storage space from the outside environment, in particular using the electrical operating component. The electrical operating component may comprise several such connection ports.

For the configuration of the heat exchanger fluid tank, it may initially be important that it provides a receiving space configured to receive and store or stock the heat exchanger fluid in the ground compaction machine. For this purpose, the heat exchanger fluid tank may have a body that forms the storage space. The body may, for example, be at least partially open at the top, at least in the vertical direction, to allow access from outside the heat exchanger fluid tank into the storage space. This may be useful for maintenance purposes, but also for replacing the electrical operating component, for example. If the body of the heat exchanger fluid tank is at least partially open at the top in the vertical direction, it is advantageous if the heat exchanger fluid tank comprises a lid that closes off the storage space from the outside environment. In particular, the lid may be removable from the body. Additionally or alternatively, one or more fastening devices may be included which secure the lid to the body, in particular in a form-fitting manner. Such devices may be detachable snap connections or similar, for example. There may be one or more sealing elements, such as a sealing lip, etc., which seal the storage space in the contact region between the lid and the body from the outside environment. The lid may be formed by the electrical operating component itself. Alternatively, it is also possible for the lid to be in the form of an adapter lid and/or for there to be several lids, each of which can be placed on the body and each of which can be adapted to different electrical operating components, in particular, for example, to electrical energy storage devices from different manufacturers.

The lid may be completely removable from the body. However, in order to make the lid captive relative to the body, it is also possible that a connecting joint is provided between the body and the lid, and that the lid is adjustable relative to the body about the connecting joint. Specifically, the lid may, for example, be adjustable relative to the body between an open position, in which the storage space is accessible from the outside, and a closed position, in which the lid closes the storage space towards the outside environment. Such a connecting joint may be a swivel joint, for example.

Various materials may be used for the design of the heat exchanger fluid tank. It may be advantageous if the heat exchanger fluid tank consists, in particular completely, of a plastic material, in particular a polymer plastic material. Such a material may be, for example, a polypropylene polymer plastic, a polyethylene polymer plastic or a polypropylene and/or polyethylene copolymer plastic. The heat exchanger fluid tank may be made of a single material. However, it is also possible for the heat exchanger fluid tank to be made of different materials, at least in some regions. For example, parts of the heat exchanger fluid tank may not be made of said one plastic material, but of a metal, for example in the form of one or more aluminum plates/strips. As described in more detail below, these regions may in particular also be used to transfer heat from the storage space to the outside environment and/or to components located outside the heat exchanger fluid tank.

The size of the heat exchanger fluid tank may vary and, in particular, may also be adapted to the size of the respective electrical operating component. For ground compaction machines of the present type, however, it has proven to be advantageous if the capacity of the heat exchanger fluid tank is in the range from 5 L to 50 L, in particular in the range from 10 L to 25 L.

During operation of the ground compaction machine, the vibrations generated by the vibration excitation device may result in a considerable vibration load on the ground compaction machine or at least on parts of the ground compaction machine. It may therefore be advantageous if one or more vibration damping elements are provided to dampen a transmission of vibrations between the electrical operating component and the heat exchanger fluid tank. For example, one or more vibration damping elements may also be provided within the storage space. In particular, these may be vibration damping elements on which the electrical operating component rests and/or which it contacts inside the storage space. Additionally or alternatively, one or more vibration damping elements may also be arranged outside the storage space between the electrical operating component and the heat exchanger fluid tank in order to minimize vibration transmission between these two components. The vibration damping elements may be elements made of an elastically deformable material, for example in the form of a rubber and/or plastic damping element.

Additionally or alternatively, the heat exchanger fluid tank may also be connected to the machine frame of the ground compaction machine via one or more vibration damping elements. These vibration damping elements may, for example, be bearings comprising an elastic material, in particular rubber and/or plastic bearings.

As explained above, the heat exchanger fluid stored within the heat exchanger fluid tank may be used as a fluid reservoir for absorbing and/or releasing thermal energy for heating and/or cooling purposes of the electrical operating component arranged at least partially within the storage space. However, this effect can also be extended to components positioned outside the storage space. For this purpose, the heat exchanger fluid tank may in particular have a contact region on its outer surface, and a component that generates heat during operation of the ground compaction machine may be in direct contact with this contact region, in particular be connected to it. The contact region may be characterized in particular by having its outer surface at least partially complementary to the corresponding contact region of this component in order to enable conductive heat transfer between the heat exchanger fluid and this component via the contact region. In this contact region in particular, the heat exchanger fluid tank may be made of a material with a comparatively high thermal conductivity, such as aluminum.

It may be advantageous if a circulation device and/or a passive turbulence generation device is arranged inside the heat exchanger fluid tank, in particular inside the storage space. The circulation device refers to an actively driven device that can be moved relative to the heat exchanger fluid tank for circulating the heat exchanger fluid within the storage space, such as an agitator. The passive turbulence generation device, on the other hand, refers to a device that generates turbulence within the heat exchanger fluid due to the shaking movements of the heat exchanger fluid tank itself. Such device may be, for example, one or more baffle plates, turbulators etc. projecting into the heat exchanger fluid. Since the heat exchanger fluid volume stored within the heat exchanger fluid tank can be a stagnant fluid volume, i.e., a fluid volume to which at least no fresh, in particular cooled, heat exchanger fluid is supplied during operation of the ground compaction machine, promoting movement of the heat exchanger fluid within the storage space can improve the heat exchange between the electrical operating component and the heat exchanger fluid itself.

The ground compaction machine and in particular the heat exchanger fluid tank may be configured such that the storage space of the heat exchanger fluid tank is completely closed during operation of the ground compaction machine, so that the heat exchanger fluid volume inside the storage space remains unchanged. In this case, the heat exchanger fluid volume stored within the storage space is therefore a fluid volume that is used exclusively for heat exchange with the electrical operating component. There is neither an inflow of heat exchanger fluid nor an outflow during operation of the ground compaction machine.

It is intended that the heat exchanger fluid tank is used in a dual function such that the heat exchanger fluid it holds, or at least a proportion of it, is consumed as a process fluid in the ongoing compaction operation of the ground compaction machine. Even for this embodiment, however, it is not intended that the heat exchanger fluid tank is integrated into a cooling circuit. Instead, the heat exchanger fluid stored in the heat exchanger fluid tank can solely flow out of the storage space, in particular in doses, during operation of the ground compaction machine. This reduces the volume of heat exchanger fluid available to absorb thermal energy within the storage space, for example. However, this may be acceptable in practical use. Specifically, the ground compaction machine comprises a sprinkling device with a fluid outlet, wherein the fluid outlet is connected to the heat exchanger fluid tank in a fluid-conducting manner, such that heat exchanger fluid contained in the heat exchanger fluid tank can discharge via the fluid outlet of the sprinkling device during operation of the ground compaction machine. The fluid outlet may, for example, have one or more fluid outlet openings, in particular along a sprinkler bar. One or more valves may be provided between the fluid outlet and the heat exchanger fluid tank in order to be able to selectively interrupt the fluid-conducting connection. Additionally or alternatively, the ground compaction machine may comprise a fluid pump that pumps heat exchanger fluid out of the storage space and feeds it to the fluid outlet, in particular under pressure.

The heat exchanger fluid tank can be filled, for example, via an opening in the heat exchanger fluid tank through which the electrical operating component can also be at least partially introduced into the storage space of the heat exchanger fluid tank. However, there may also be an additional or sole and/or exclusive filling opening for filling the storage space. The filling opening is preferably located in a region on the upper side of the heat exchanger fluid tank located at the top in the vertical direction, or at least in an upper third of a side wall of the heat exchanger fluid tank in the vertical direction. Additionally or alternatively, the heat exchanger fluid tank may have a drain opening, in particular in fluid-conducting connection with a lowest region of the bottom of the heat exchanger fluid tank in the vertical direction. Draining the heat exchanger fluid can be advantageous, for example, for transportation purposes and/or to make the ground compaction machine winter-proof. The drain opening may have a valve, for example a stopcock or the like. Additionally or alternatively, the heat exchanger fluid tank may also comprise one or more venting and/or ventilation openings. These may be used to enable pressure balance between the storage space and the outside environment. It is advantageous if the venting and/or ventilation openings, as the filling opening, are arranged on an upper side of the heat exchanger fluid tank. The venting and/or ventilation opening may have a filter stage, in particular a mechanical one, for example in the form of a fabric filter, to prevent dust from entering from outside the ground compaction machine. The vent and/or ventilation opening preferably opens into a non-wet region of the storage space.

Operating situations may arise in which carrying the heat exchanger fluid tank with the ground compaction machine is considered disadvantageous, for example for reasons of space, etc. For these operating situations, it is advantageous if the heat exchanger fluid tank is detachably arranged on the ground compaction machine and has no other connection points, in particular to the fluid line of the heat exchanger fluid, apart from, in particular, detachable retaining connections. It is therefore also ideal, particularly in this context, if the at least one electrical operating component is mounted on the ground compaction machine independently of the heat exchanger fluid tank. This means that it is particularly preferred if the electrical operating component, which projects at least partially into the heat exchanger fluid tank, is mounted on the ground compaction machine such that it is free from bearing forces relative to the heat exchanger fluid tank.

Due to the volume of heat exchanger fluid to be carried along, it may be advantageous for obtaining an optimized mass distribution if the ground compaction machine comprises an electric motor, and if this electric motor is arranged in front of the heat exchanger fluid tank in the forward direction of the ground compaction machine, and more preferably is free of overlap in the vertical direction with respect to the heat exchanger fluid tank. Additionally or alternatively, the electric motor and the heat exchanger fluid tank may be arranged to at least partially overlap in the vertical direction.

The ground compaction machine preferably comprises a fill level sensor for determining a fill level of the heat exchanger fluid within the heat exchanger fluid tank. The fill level sensor may be a float sensor or the like, for example. Additionally or alternatively, a transparent side wall region may be included in the heat exchanger fluid tank so that the current fill level of heat exchanger fluid inside the storage space can be viewed directly from outside the ground compaction machine. The fill level sensor or the fill level sensor device may be configured such that it determines the current fill level of heat exchanger fluid within the storage space within a target range. Additionally or alternatively, the fill level sensor may be configured such that it detects limit values, wherein possible limit values may be maximum filled and/or maximum low fill levels with and/or without the electrical operating component projecting into the storage space.

Additionally or alternatively, the ground compaction machine may comprise a temperature sensor for determining a temperature of the heat exchanger fluid within the heat exchanger fluid tank. Again, limit values for maximum high and/or maximum low temperatures may be defined here as well. Such a temperature sensor may, for example, be a temperature transducer or the like.

It is also possible that the ground compaction machine is configured such that a temperature control device for cooling and/or heating the heat exchanger fluid is provided in the heat exchanger fluid tank, the temperature control device being configured such that cooling and/or heating of the heat exchanger fluid takes place without simultaneous withdrawal and/or supply of heat exchanger fluid from and into the heat exchanger fluid tank. The heat exchanger fluid tank is therefore still configured as a type of “heat exchanger fluid bath” without being integrated into a heat exchanger fluid cooling circuit, i.e., without heat exchanger fluid being exchanged. The temperature control device may, for example, be a heating coil and/or a cooling finger immersed in the heat exchanger fluid.

The ground compaction machine may comprise a control unit which, for example, monitors and/or processes the sensor data received from the sensors. If the fill level of the heat exchanger fluid within the heat exchanger fluid tank is too low, for example, and/or the temperature of the heat exchanger fluid rises above a defined threshold temperature, the control unit may be configured such that it intervenes in the machine control system, for example. Such an intervention may, for example, consist in limiting the maximum turnover of electrical energy of one or more electrical operating components per time unit in order to counteract further heat development to an undesirable extent.

The ground compaction machine may comprise a display device which is configured for audible and/or visually perceptible display of, for example, one or more of the measured values determined by one or more of the sensors and/or information derived therefrom. The display device may be controlled by the control unit and may, for example, take the form of a display and/or one or more signal lights and/or a loudspeaker, etc. Transmission to a mobile device, such as a smartphone, remote control or the like, is also possible.

The specific configuration of the ground compaction machine may vary. In a preferred embodiment, the ground compaction machine is a vibratory rammer. Such rammer comprises, as a machine frame, a superstructure on which a manual guide device, in particular a guide bracket, is arranged, usually via vibration damping elements. A substructure with a ground contacting device configured as a tamping foot may further be adjustably arranged on the superstructure. In this case, the vibration excitation device may be configured in particular as a crank drive. Regarding the arrangement of the heat exchanger fluid reservoir, the latter may in particular be mounted on the manual guide device or on the superstructure. An electric motor, in particular for driving the crank drive, may be arranged in particular on the superstructure. An electrical energy storage device may be positioned in particular on the hand guide device and/or on the superstructure.

Alternatively, the ground compaction machine can also be configured as a vibratory plate compactor. The vibratory plate compactor may be provided with a ground contacting device in the form of a compaction plate. The vibration excitation device, in particular in the form of one or more imbalance exciters, may be mounted thereon. The one or more drives, preferably in the form of an electric motor, of the one or more imbalance exciters may be arranged directly on an upper side of the compaction plate or on a superstructure connected to the compaction plate via vibration damping elements and arranged above the compaction plate. The superstructure may additionally or alternatively carry other components of the vibratory plate compactor, such as one or more energy storage devices, one or more power converters, a manual guide device, such as a guide bracket or a guide drawbar. The heat exchanger fluid reservoir may be arranged on the compaction plate, the superstructure or on the manual guide device. The vibratory plate compactor may be a forward-running or reversing vibratory plate compactor.

The ground compaction machine may also be configured as a trench roller. The machine frame of the trench roller may be configured in particular as an articulated machine frame with a front carriage and a rear carriage, which are connected to each other via an articulated joint device. The trench roller may comprise two or more roller drums arranged one behind the other in one working direction. The vibration excitation device may have one or more imbalance exciters. In particular, at least one imbalance exciter may be associated with each of the roller drums. The trench roller may have an electromotive or electrohydraulic drive system. In addition to one or more electric motors, it may have one or more electrical energy storage devices and one or more power converters as electrical operating components. The heat exchanger fluid reservoir can preferably be mounted on the machine frame.

Finally, the ground compaction machine may be a roller, in particular a hand-guided roller, including a dual-vibration roller. The roller comprises a machine frame on which one or more roller drums may be mounted. The vibration excitation device may have one or more imbalance exciters. In particular, at least one imbalance exciter may be associated with each of the roller drums. The roller may have an electromotive or electrohydraulic drive system. In addition to one or more electric motors, it may have one or more electrical energy storage devices and one or more power converters as electrical operating components. The heat exchanger fluid reservoir can preferably be mounted on the machine frame. The roller may be configured as a hand-guided roller with a manual guide device, in particular one that is hinged to the machine frame.

Ideally, the ground compaction machine is a hand-guided ground compaction machine with a manual guide device. Additionally or alternatively, it may be remote-controlled or configured to move/operate autonomously.

With regard to the specific configuration of the ground compaction machine, there are various preferred alternatives. In particular, the ground compaction machine is a ground compaction machine driven exclusively by an electric motor.

A further aspect of the invention relates to a method for operating a ground compaction machine, in particular a ground compaction machine according to the invention, as described above. In particular, the ground compaction machine may comprise a machine frame, a ground contacting device mounted movably on the machine frame, a vibration excitation device which sets the ground contacting device in a vibrating and/or tamping motion in a compaction operation, and an electrical operating component comprising a housing. With regard to these individual possible components of the ground compaction machine, reference is also made to the preceding discussion of the ground compaction machine according to the invention, which may also be used in a corresponding manner in a ground compaction machine intended for carrying out the method according to the invention.

According to an essential aspect of the method according to the invention, heat or thermal energy is transferred, in particular exclusively, in a conductive manner between the heat exchanger fluid and the electrical operating component within a heat exchanger fluid tank during compaction operation of the ground compaction machine. With regard to a possible configuration of the heat exchanger fluid tank itself, reference is also made at this point to the previous information. In contrast to conventional cooling fluid cooling systems, the heat exchanger fluid is therefore not continuously guided past the electrical operating component, thereby removing or supplying thermal energy. Instead, the electrical operating component is at least partially immersed in the heat exchanger fluid and is thus merely encapsulated by the heat exchanger fluid, in particular in the form of a stagnant volume of fluid stored by the storage space, which does not flow around it.

It is possible that the electrical operating component is arranged inside the heat exchanger fluid tank such that the heat exchanger fluid directly wets the housing of the electrical operating component, so that heat is transferred from the housing directly into the heat exchanger fluid. In this case, the heat exchange therefore takes place directly between the housing of the electrical operating component and the heat exchanger fluid inside the heat exchanger fluid tank.

It may be advantageous if the heat exchanger fluid is completely stored in the storage space of the heat exchanger fluid tank during operation of the ground compaction machine. In other words, no exchange of heat exchanger fluid of the heat exchanger fluid tank out of the storage space and/or into the storage space for cooling and/or heating purposes is intended during compaction operation of the ground compaction machine.

It is intended that the heat exchanger fluid is also used as a consumable fluid for the ongoing working process of the construction machine, specifically as a sprinkling fluid. In this case, heat exchanger fluid is thus consumed by the sprinkler system during operation of the ground compaction machine.

### BRIEF DESCRIPTION OF THE DRAWINGS

The invention will be explained in more detail below by reference to the embodiment examples shown in the figures. In the schematic figures:

FIG. 1 is a side view of a ground compaction machine of the vibratory rammer type;

FIG. 2 is a partial cross-sectional view of the vibratory rammer of FIG. 1;

FIG. 3 is a side view of a ground compaction machine of the vibratory plate compactor type;

FIG. 4 is a side view of a ground compaction machine of the trench roller type;

FIG. 5 is a side view of a ground compaction machine of the roller type;

FIG. 6 is a cross-sectional view of a heat exchanger fluid tank according to a first embodiment;

FIG. 7 is a cross-sectional view of a heat exchanger fluid tank according to a second embodiment;

FIG. 8 a cross-sectional view of a heat exchanger fluid tank according to a third embodiment;

FIG. 9 is a cross-sectional view of a heat exchanger fluid tank according to a fourth embodiment;

FIG. 10 is a cross-sectional view of a heat exchanger fluid tank according to a fifth embodiment;

FIG. 11 is a cross-sectional view of a heat exchanger fluid tank according to a sixth embodiment;

FIG. 12 is a cross-sectional view through a heat exchanger fluid tank according to a seventh embodiment with a first adapter piece;

FIG. 13 is a cross-sectional view through the heat exchanger fluid tank according to the seventh embodiment with a second adapter piece;

FIG. 14 is a cross-sectional view through a heat exchanger fluid tank according to an eighth embodiment with a first adapter piece;

FIG. 15 is a cross-sectional view through a heat exchanger fluid tank according to a ninth embodiment with a first adapter piece;

FIG. 16 is a cross-sectional view through a heat exchanger fluid tank according to a tenth embodiment with a first adapter piece; and

FIG. 17 is a flow chart of the method.

Like parts or functionally like parts are designated by like reference numerals in the figures. Recurring parts are not necessarily designated separately in each figure. Further, features of individual embodiments may be combined with features of other embodiments if technically feasible.

### DETAILED DESCRIPTION

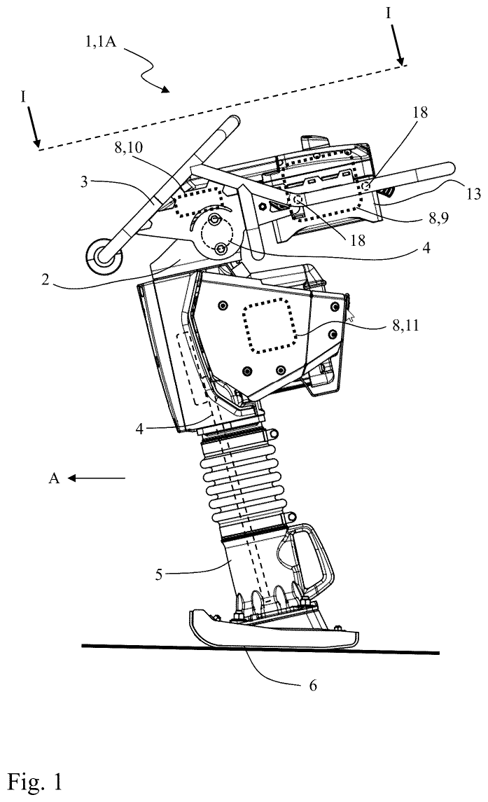

A ground compaction machine 1, specifically of the vibratory rammer type, is shown in FIG. 1 in a side view. The ground compaction machine 1 may have a machine frame 2 forming the superstructure of the ground compaction machine 1. A manual guide device 3, for example in the form of a guide bracket, may be hinged to the machine frame via vibration damping elements 4. The ground compaction machine 1 may also have a substructure 5 with a ground contacting device 6 in the form of a tamping foot. It may further comprise a vibration excitation device 7 (in this embodiment example in the form of a crank drive, which is only indicated). The ground compaction machine may have one or more electrical operating components 8. Such electrical operating components 8 may be, for example, an electrical energy storage device 9, a power converter 10 and/or an electric motor 11. These electrical operating components 8 may together form an electrical drive train, in particular for driving the vibration excitation device 7.

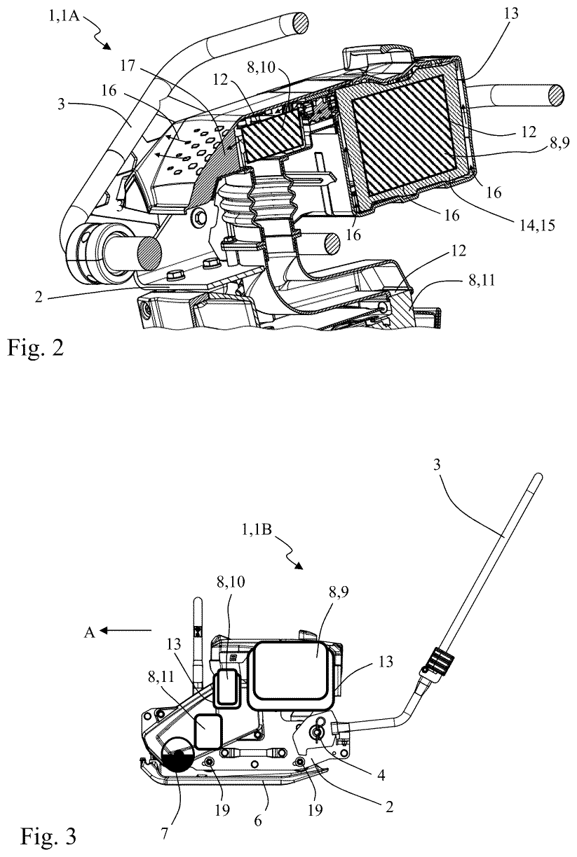

FIG. 2 illustrates further possible configuration details in a cross-sectional view along a sectional plane I-I of FIG. 1 extending in the forward direction A of the ground compaction machine 1 and in the vertical direction approximately through the center of the upper part of the ground compaction machine 1. The electrical operating components 8 may each comprise a housing 12. It will be appreciated that the individual housings 12 may differ from one another, particularly in terms of their shape.

During operation of the ground compaction machine 1, the individual electrical operating components 8 may generate heat, for example when supplying, converting and/or consuming electrical energy. For example, in order to reduce the heat load on one or more of the electrical operating components 8, the ground compaction machine 1 may comprise one or more heat exchanger fluid tanks 13. The heat exchanger fluid tank 13 may have a storage space 14 in which heat exchanger fluid 15 is stored. Heat energy can be exchanged directly between the electrical operating component 8 and the heat exchanger fluid 15 by conductive heat exchange via a heat exchange surface 16, which may, for example, be formed directly by the housing 12 of the electrical operating component 8. For this purpose, the electrical operating component 8 in the present embodiment example may, for example, be virtually completely immersed in the heat exchanger fluid 15 within the storage space 14. The heat exchanger fluid 15 can at least partially wet the housing 21 of the electrical operating component 8 directly.

The storage space 14 of the heat exchanger fluid tank 13 may in particular be configured as a closed storage space in which the heat exchanger fluid 15 is stored without exchanging heat exchanger fluid during compaction operation of the ground compacting machine 1. This means that the heat exchanger fluid 15 is stored as a kind of stagnant fluid volume that is not integrated into a circulating cooling circuit. The heat absorption capacity of the heat exchanger fluid 15 stored within the storage space 14 is therefore also comparatively limited, but also sufficient for the present application. However, when the electrical operating component 8, which is configured as an electrical energy storage device 9, generates heat, for example, the efficiency of the thermal energy transfer from the electrical energy storage device 9 via the heat exchange surface 16 of the housing 12 of the electrical operating component 8 decreases as the heat exchanger fluid 15 heats up, since the heat exchanger fluid 15 is not actively cooled in a cooling circuit running externally to the heat exchanger fluid tank 13 and fed back into the storage space 14. In the light of the usual operating intervals of a ground compaction machine 1 of this type, however, this is acceptable.

However, it is possible that the heat exchanger fluid tank 13 is additionally cooled on its outside with the aid of a cooling air device 17. This device may, for example, be configured such that it generates an air flow 16 on the outside of the heat exchanger fluid tank 13. The cooling air device 17 may comprise one or more air conveying devices not shown in detail in the figures, for example a suction fan, and/or a cooling air passage, for example in the form of one or more air ducts. However, it is essential that the heat exchanger fluid 15 inside the heat exchanger fluid tank 13 is not removed from the storage space 14 for cooling purposes.

The heat exchanger fluid 15 may be a liquid or a mixture of liquids. In particular, this can mean that the heat exchanger fluid 15 may be a fluid that is in a liquid aggregate state at least in a temperature range greater than 0° C. to 90° C., particularly at least in a temperature range of −20° C. to 90° C. The heat exchanger fluid 15 may, for example, be water, a water-glycol mixture, oil or another dielectric fluid and/or a mixture thereof.

It is possible that the heat exchanger fluid tank 13 is arranged on the hand guiding device 3 in a vibration-damped manner relative to the latter via vibration damping elements 18. If the heat exchanger fluid tank 13 is arranged on the machine frame 2 of the ground compaction machine 1, it may be vibration-damped relative to the machine frame 2 by means of vibration damping elements 18 (FIG. 1).

FIG. 3 shows a ground compaction machine 1 configured as a vibratory plate compactor 1B. A significant difference to the ground compaction machine 1 configured as a vibratory rammer as shown in FIG. 1 is that the vibration excitation device 7 may be configured as one or more imbalance exciters. In this case, the ground contacting device 6 forming a substructure of the ground compaction machine 1 may be configured as a base plate to which the one or more imbalance exciters of the vibration excitation device 7 can be directly attached. The base plate may be connected via vibration damping elements 19 to the superstructure of the ground compaction machine 1, which is configured as a machine frame 2. The ground compaction machine may further have a manual guide device 3 in the form of a guide bracket connected to the machine frame 2 via vibration damping elements 4.

The ground compaction machine 1 according to FIG. 3 may also have one or more electrical operating components 8. For example, one or more electrical energy storage devices 9 may be provided. Such electrical operating components 8 may be arranged on the hand guide device 3 and/or the machine frame 2 and/or the ground contacting device 6. Additionally or alternatively, the ground compaction machine 1 may comprise one or more power converters 10 as electrical operating components 8. These may likewise be arranged on the hand guide device 3 and/or the machine frame 2 and/or the ground contacting device 6. Additionally or alternatively, the vibratory plate compactor type ground compaction machine 1 may comprise one or more imbalance exciters, which together may form the vibration excitation device 7. In particular, these may be arranged directly on the ground contacting device 6 and driven by an electrical operating component 8 in the form of an electric motor 11. It is possible to drive the one or more imbalance exciters indirectly by one or more electric motors 11, for example by interposing a belt and chain drive. However, it is also possible for the one or more imbalance exciters to be driven directly by one or more electric motors 11. The one or more electric motors 11 may be arranged or mounted directly on the ground contacting device.

The embodiment example according to FIG. 3 illustrates that the ground compaction machine 1 may have not only one heat exchanger fluid tank 13, but that embodiments are also included in the invention which comprise multiple heat exchanger fluid tanks 13. One of the operating components 8 arranged at least partially within a heat exchanger fluid tank 13 may, for example, be the electrical energy storage device 9. Additionally or alternatively, however, an electrical operating component configured as a power converter 10 may be arranged in a heat exchanger fluid tank 13. If both of these electrical operating components 8 are each to be arranged in a heat exchanger fluid tank 13, it is possible, as shown in FIG. 3, to provide a separate heat exchanger fluid tank 13 on the ground compaction machine 1 for each of the electrical operating components 8. These tanks may, for example, both be mounted on the machine frame 2. Alternatively, however, a common heat exchanger fluid tank 13 may be comprised by the ground compaction machine 1, into the storage space 14 of which the at least two or more electrical operating components 8 project together or in the storage space 14 of which they are positioned together.

The ground compaction machine 1 configured as a vibratory plate compactor 1B as shown in FIG. 3 may likewise be a ground compaction machine 1 driven solely by electrical energy.

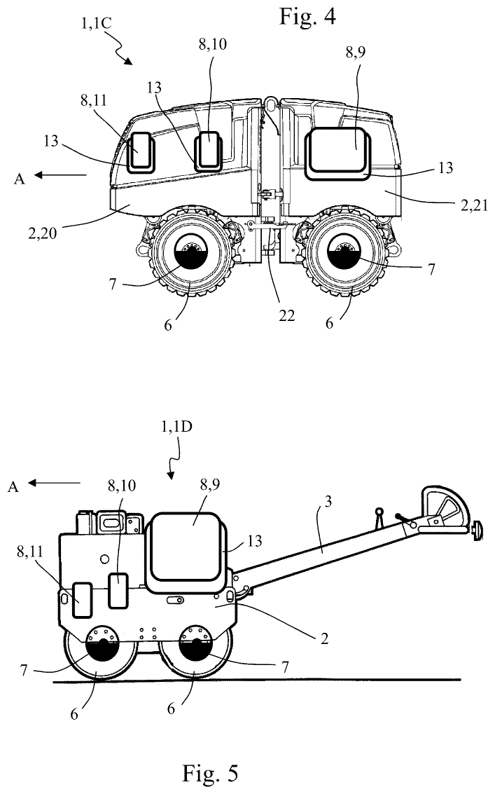

FIG. 4 shows a side view of possible features of a ground compaction machine 1 configured as a trench roller 1C. In contrast to the two previous examples of a ground compaction machine 1, the ground contacting device 6 in this case is configured in the form of several cylindrical roller drums, which roll on the ground during travel and compaction operation. One or more vibration excitation devices 7, in particular configured as imbalance exciters, may be arranged inside these roller drums. The machine frame 2 may be configured as an articulated machine frame 2 comprising a front carriage 20 and a rear carriage 21, which are connected to each other via an articulated joint device 22.

Several of the electrical operating components 8, in particular one or more electrical energy storage devices 9, one or more power converters 10 and/or one or more electric motors 11, may be mounted together on the front carriage 20 and/or on the rear carriage 21.

The ground compaction machine 1 may have an all-electric or electro-hydraulic drive system, particularly in the case of the trench roller configuration.

Finally, FIG. 5 illustrates a ground compaction machine 1 of the roller type, more specifically a hand-guided dual-vibration roller. The manual guide device 3 may therefore also be configured as a guide drawbar on a ground compaction machine 1.

In particular for the ground compaction machine 1 having a ground contacting device 6 rolling on the ground U, it is possible that it comprises one or more electric motors 11 configured as traction drive motors and/or as drive motors of the vibration excitation device 7.

All of the ground compaction machines 1 illustrated in more detail in FIGS. 1 to 5 may be configured in particular as hand-guided and/or semi-autonomously and/or autonomously operating ground compaction machines 1.

Individual or several features of the respective embodiments of the ground compaction machines 1 in FIGS. 1 to 5 may also be combined with one another if possible in view of the type of compaction work process of the respective type of ground compaction machine 1.

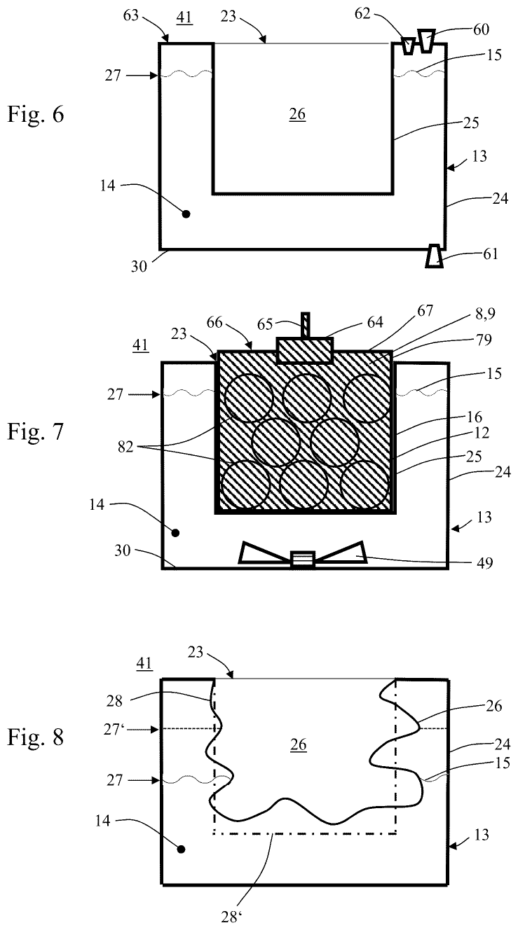

FIGS. 6 to 16 illustrate various embodiments of the heat exchanger fluid tank 13 and/or the respective electrical operating component 8. The electrical operating components 8 shown in FIGS. 6 to 16 may be one or more electrical energy storage devices 9 and/or power converters 10 and/or electric motors 11. The energy storage device 9 may have one or more energy storage elements 82 or cells, as shown in FIG. 7 as an example.

All of the embodiments of the heat exchanger fluid tank 13 illustrated in the embodiment examples comprise a storage space 14 at least partially surrounded by tank outer walls 24, in which heat exchanger fluid 15 is held (in FIGS. 6 to 16, the upper fluid level edge is designated with 15; in the individual embodiment examples, the storage space 14 is thus filled with heat exchanger fluid 15 up to this point, for example). The tank walls may form a kind of trough-like container volume, which may have a receiving opening 23 that is open upwards in the vertical direction 84 towards the external environment 41.

Part of the heat exchanger fluid tank 13 is also a receiving space 26 inside the heat exchanger fluid tank 13, as indicated for example in FIGS. 6 and 8, in which no electrical operating component 8 is inserted into the heat exchanger fluid tank 13. This receiving space be accessible from outside the heat exchanger fluid tank 13 via the receiving opening 23, in particular for inserting and/or removing the respective electrical operating component 8.

All of the embodiments shown have at least one heat exchange surface 16, via which heat can be exchanged conductively between the electrical operating component 8 and the heat exchanger fluid 15 within the storage space 14 at least when the electrical operating component 8 projects at least partially into the storage space 14.

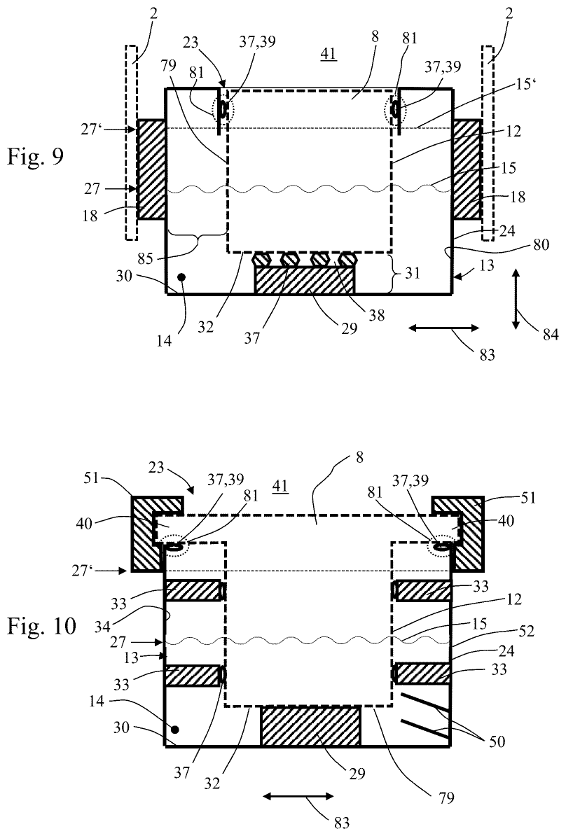

Two variants are possible for the configuration of the heat exchange surface 16 and are included in the invention. The embodiments explained in FIGS. 6 to 8 relate to variants in which one or more inner walls 25 of the heat exchanger fluid tank 13 itself form part of the heat exchange surface 16 together with the housing 12 of the electrical operating component 8. In these variants, the conductive heat exchange between the electrical operating component 8 and the heat exchanger fluid 15 thus takes place via the housing of the electrical operating component 8 and the part of the heat exchange surface 16 formed by the heat exchanger fluid tank 13. In the embodiments of FIGS. 9 to 16, on the other hand, the heat exchanger fluid 15 wets the housing 12 of the electrical operating component directly, so that the conductive heat exchange between the electrical operating component 8 and the heat exchanger fluid 15 can take place directly to the heat exchanger fluid 15 via the housing 12 of the electrical operating component.

FIG. 6 explains further possible configuration details of a heat exchanger fluid tank 13. For example, the receiving space 26 may be formed by dimensionally stable tank inner walls 25. Ideally, these may be configured such that the three-dimensional outer surface of the tank inner walls 25 facing the receiving space 26 is complementary to the mating contact surface of the electrical operating component 8, in order to exclude the occurrence of an air gap between the external surface of the housing 12 of the electrical operating component 8 and the tank inner walls 25 as far as possible or to keep it as small as possible locally, so that a conductive heat exchange between the electrical operating component 8 and the heat exchanger fluid 15 is interrupted as little as possible by an air layer occurring in certain areas.

The storage space 14, which is separated from the receiving chamber 26 by the tank inner walls 25, is filled with the heat exchanger fluid 15 up to a fill level 27. In FIG. 7, an electrical operating component 8, for example in the form of an electrical energy storage device 9, is inserted into the receiving space 26. If the electrical operating component 8 generates heat during operation of the ground compaction machine 1, this heat can be transferred to the heat exchanger fluid 15 by means of conductive heat transfer through the housing 12 of the electrical operating component and through the tank inner wall 25. Conversely, a transfer of thermal energy from the heat exchanger fluid 15 to the electrical operating component 8 is possible as well.

FIG. 8 illustrates an embodiment example of the heat exchanger fluid tank 13 in which the tank inner wall 25 or the partition wall to the receiving space 26 is bounded by a contact membrane 28 made of a flexible membrane material, which is fluid-tight in particular with respect to the heat exchanger fluid 15. If the electrical operating component is now inserted into the receiving space 26 through the receiving opening 23, the contact membrane 28 rests against the outer surface 79 of the housing 12 of the electrical operating component 8, as illustrated in FIG. 8 by the dashed line 28′. Heat exchange between the electrical operating component and the heat exchanger fluid 15 thus takes place in this embodiment example by means of successive conductive heat transfer through the housing 12 of the electrical operating component and through the contact membrane 28 of the heat exchanger fluid tank 13 to the heat exchanger fluid 15. By inserting the electrical operating component 8, the fill level 27 of the heat exchanger fluid 15 within the heat exchanger fluid tank 14 can rise to a fill level 27′.

According to the variants illustrated in the embodiment examples of FIGS. 9 to 16, the electrical operating component 8 is at least partially immersed with its housing 12 directly in the heat exchanger fluid 15 stored in the storage space 14 and is thus directly wet by it. In these embodiments, heat is thus exchanged between the electrical operating component 8 and the heat exchanger fluid 15 by means of conductive heat transfer only through the housing 12 of the electrical operating component 8 to the heat exchanger fluid 15. For each of these embodiments, a fill level 27 is indicated which corresponds to the fill level of the heat exchanger fluid 15 within the storage space 14 when the electrical operating component has been removed from the heat exchanger fluid tank 13, and a fill level 27′is indicated which corresponds to the fill level of the heat exchanger fluid 15 within the storage space 14 when the electrical operating component 8 has been inserted into the heat exchanger fluid tank 13.

In particular also for these embodiments in which the housing 12 is wet directly, it is possible that one or more support elements 29 are provided in the storage space 14. These may project upwards in the vertical direction from a lower base wall 30 of the storage space 14 and serve as a contact surface or insertion limit for the electrical operating component 8. In this way, it can be achieved that the electrical operating component 8 is mounted with its bottom wall 32 at a distance 31 in the vertical direction 84 from the bottom wall 30 of the storage space 14 or the heat exchanger fluid tank 13 within the receiving space 26, so that at least substantial parts of the bottom wall 32 formed by the housing 12 of the electrical operating component 8 may also be wet directly with heat exchanger fluid 15. Additionally or alternatively, the electrical operating component 8 may be spaced with its lateral outer surface 79 at a horizontal distance 85 in the horizontal direction 83 from the inner surface 80 of the storage space 14 or the heat exchanger fluid tank 13.

Additionally or alternatively, it is also possible that one or more lateral guide elements 33 are provided in the storage space 14. This is illustrated in more detail, for example, in the embodiment example of FIG. 10. The side guide elements 33 may, for example, be projections or the like projecting at least partially horizontally from a tank side wall 34 into the interior of the storage space 14. The housing 12 of the electrical operating component 8 can rest against these, in particular in a form-fitting manner, and thus be stabilized in its relative position in the horizontal direction 83 relative to the heat exchanger fluid tank 13.

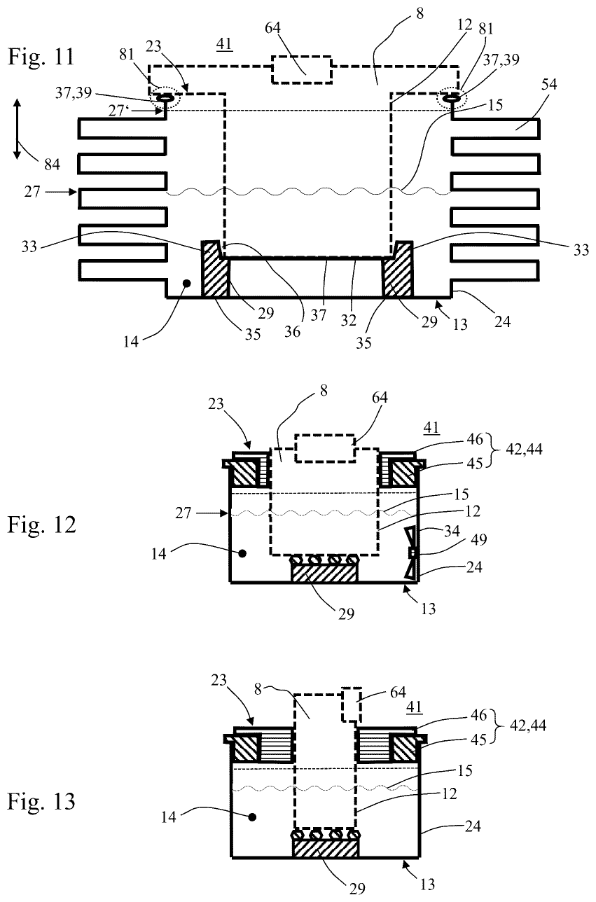

In the embodiment example shown in FIG. 11, a supplementary or alternative embodiment of the support elements 29 and the lateral guide elements 33 is illustrated. According to FIG. 11, these may be configured as stabilizing elements 35 combined with one another, which simultaneously have a surface for seating a part of the bottom wall 32 of the housing 12 of the electrical operating component 8 as part of a support element 29 as well as side wall elements as lateral guide elements 33 which protrude from it in the vertical direction 84 and at least partially embrace the housing 12 of the electrical operating component 8 at the level of a side wall of the housing 12. The stabilizing elements 35 may additionally or alternatively also comprise a centering aid, for example in the form of an entry slope 36, along which the housing 12 can slide when inserted into the receiving space 26 and is guided into its, ideally centered, end position.

Due to the vibration loads that may occur during operation of the ground compaction machine 1, it may be advantageous to dampen the heat exchanger fluid tank 13 relative to the ground compaction machine 1 and/or the electrical operating components 8 relative to the heat exchanger fluid tank 13 to prevent a transmission of vibrations. For example, vibration damping elements 18 (FIG. 9) may be part of a vibration-damped connection of the heat exchanger fluid tank 13 to a machine frame 2 and/or a manual guide device (not shown in FIG. 9) of the ground compaction machine 1.

Additionally or alternatively, however, one or more vibration damping elements 37 may also be included in the assembly of heat exchanger fluid tank 13 and electrical operating component 8, which dampen vibration transmission between these two components. In the embodiment example shown in FIG. 9, for example, vibration damping elements 37 may be provided in a dry region, i.e., a region not wet by the heat exchanger fluid 15, in the upper edge region of the electrical operating component 8 and an inwardly curved inner edge in the region of the receiving opening 23. In particular, these dampen vibration transmission between the electrical operating component 8 and the heat exchanger fluid tank 15 in a horizontal direction 83. Additionally or alternatively, one or more vibration damping elements 37 may be arranged in the region between the bottom wall 32 of the electrical operating component 8 and the support element 29 or its support surface. Such vibration damping elements 37 may thus in particular also be wet by the heat exchanger fluid 15. In particular, these vibration damping elements 37 dampen vibration transmission between the electrical operating component 8 and the heat exchanger fluid tank 15 in a vertical direction 84. As illustrated in FIG. 9, the vibration damping elements 37 acting in the vertical direction 84 and the vibration damping elements acting in the horizontal direction 83 may also be combined with one another.

According to the embodiment example shown in FIG. 9, the vibration damping elements 37 may be configured as nub-like or strip-like elements, so that heat exchanger fluid 15 can enter the resulting gaps 38 and in particular, for example, wet the bottom wall 32 of the electrical operating component 8 directly also in the region of the vibration damping elements 37 for an optimized conductive heat exchange process. Alternatively, in particular the vibration damping element 37 acting towards the bottom wall 32 of the electrical operating component 8 may also be configured in the form of a damping mat, as shown, for example, in the embodiment example according to FIG. 11.

In the embodiment example of FIG. 10, a further additional or alternative possibility for positioning the vibration damping elements 37 is shown, according to which these may also be arranged within the volume of heat exchanger fluid 15 for damping a vibration transmission in the horizontal direction 83, for example on the end faces of one or more of the lateral guide elements 33 facing the electrical operating component 8.

In particular in order to counteract an escape of heat exchanger fluid 15 from the storage space 14 into the outside environment, it may be advantageous if the storage space 14 is closed or sealed off from the outside environment, in particular also in cooperation with the electrical operating component 8. For this purpose, the storage space 14 may be configured as a hollow space closed off from the outside environment by parts of the heat exchanger fluid tank 15, as illustrated, for example, in FIGS. 6 to 8.

However, it is also possible that the electrical operating component 8 closes the receiving opening 23 of the heat exchanger fluid tank to the outside environment 41 in a state in which it is inserted into the receiving space 26. In these embodiments, the electrical operating component 8 thus has a dual function, specifically as an electrical operating component per se and as a lid for closing the receiving opening 23.

One way to achieve this dual function is shown in the example shown in FIG. 9. The housing 12 of the electrical operating component 8 is formed in a head region almost complementary to the contour of the receiving opening 23, so that the receiving opening 23 is almost completely closed by the inserted electrical operating component 8. In addition, the vibration damping elements 37 described above may be arranged in this area, which in this case can also act as sealing elements 39 and may be configured as an O-ring seal, for example.

Additionally or alternatively, the electrical operating component 8, in particular its housing 12, may have a contact collar 40, in particular in the form of a support collar, which, in particular when projected into a horizontal reference plane, overlaps the surface of the receiving opening 23 in this projection at least partially and in particular completely circumferentially. This is the case, for example, in the embodiments shown in FIGS. 10 and 11. One or more vibration damping elements 37 and/or sealing elements 39 may also be provided in the contact or support region of this contact collar 40 on the heat exchanger fluid tank 13. With the aid of the sealing elements 39, a sealing region 81 (FIGS. 9, 10 and 11) can be provided in which the storage space 14 is sealed off from the external environment 41, ideally in a fluid-tight manner.

A further alternative for closing the storage space 14 towards the external environment 41 is to provide a lid 42 separate from the electrical operating component, with which, for example, the receiving opening 23 can be closed.

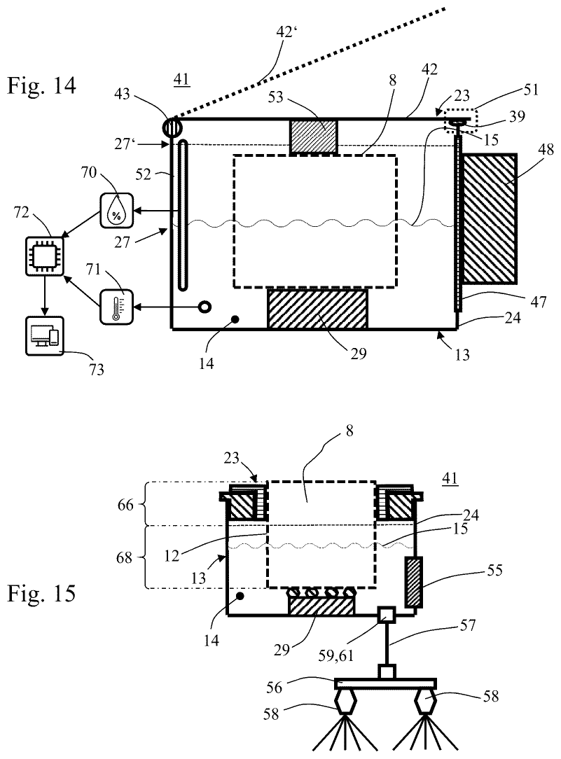

In the embodiment example shown in FIG. 14, a lid 42 is provided for this purpose, which is configured to cover the entire receiving opening 23. The lid 42 may be configured as an element that can be completely removed from the heat exchanger fluid tank 15 or, as shown in the embodiment example according to FIG. 14, may be connected to the heat exchanger fluid tank 15 in an articulated manner via a connecting joint 43, in particular a swivel joint. The open position (and beyond) that can be reached by the lid 43 shown in a closed position is shown in FIG. 14 with the lid 43′as an example.

A further additional or alternative way of using a lid 42 to close the receiving opening 23 is shown in the embodiment examples according to FIGS. 12 and 13. The heat exchanger fluid tank 15 is identical in both figures. Differences exist in the dimensions of the electrical operating component 8 projecting into the storage space 14 and the configuration of the lid 42. In this case, the lid 42 may be configured as an adapter lid 44 with a lid body 45 and an adapter piece 46. The adapter piece 46 is replaceable on the lid body 45 and together with the latter forms an overall lid. The adapter piece 46 has a through-opening 47 through which the electrical operating component 8 projects from outside the receiving space 26 into the heat exchanger fluid 15 stored in the storage space 14. Compared to the electrical operating component 8 in FIG. 12, the electrical operating component 8 in FIG. 13 is narrower, for example. This difference may now be compensated for by selectively replacing an adapter piece 46 that is adapted to the respective electrical operating component 8.

In order to ensure that the electrical operating component 8 and, if present, the lid 42 are positioned safely and reliably on and/or in the heat exchanger fluid tank 13, one or more fixing devices 51 may be provided. The fixing device 51 may, for example, be configured such that it fixes the electrical operating component 8, in particular its housing 12, relative to, in particular, a body 52 of the heat exchanger fluid tank 13, for example in the form of a tensioning and/or snapping and/or clamping fastener, as illustrated in the embodiment example according to FIG. 10. Additionally or alternatively, the fixing device 51 may be configured such that it fixes a lid 42 relative to, in particular, a body 52 of the heat exchanger fluid tank 13, as indicated, for example, in the embodiment example of FIG. 14. Such a fixing device 51 may also take the form of a tensioning and/or snapping and/or clamping fastener. In particular in this context, the lid 42 and/or the electrical operating component 8 may comprise a contact pressure element 53, such as an element made of an elastic material, which is arranged between the lid 42 and the electrical operating component 8 such that it transmits a contact pressure force from the lid 42 to the electrical operating component 8 when the lid 42 is held in its closed position by the fixing device 51.

The use of the heat exchanger fluid 15 for the release and/or absorption of thermal energy by means of conductive heat transport need not be limited to the electrical operating component 8 arranged at least partially within the receiving space 26, but may also be extended to elements arranged outside the receiving space 26. For this purpose, in particular, the heat exchanger fluid tank 13 may have a contact region 47 on its tank outer wall 24, as shown, for example, in the embodiment example shown in FIG. 14. In particular, the contact region 47 may be configured to be at least partially complementary to a component 48 in contact with it, which generates heat or cold during operation of the ground compaction machine, in order to ensure that the two elements are in contact with one another as extensively as possible. Thermal energy can be exchanged between the component 48 and the heat exchanger fluid 15 via the contact region by means of conductive heat exchange.

Even if it may be advantageous if the heat exchanger fluid tank 13 is made from a single material, for example from a polymer plastic, and/or is manufactured in particular by means of injection molding and/or blow molding, it is possible to form the heat exchanger fluid tank 15 from different materials at least in some regions. Particularly for the contact region 47, the use of a wall material that has a relatively higher thermal conductivity compared to the wall material of the remaining heat exchanger fluid tank 13, such as a metal plate and/or a suitable composite material, has proven to be advantageous.

In order to keep the heat distribution within the heat exchanger fluid 15 stored in the storage space 14 as homogeneous as possible within the volume of heat exchanger fluid 15, it is possible that one or more circulation devices 49 are arranged in the storage space 14, which cause and/or promote movement and mixing of the heat exchanger fluid 15 within the storage space 14. For this purpose, the circulation device 49 may, for example, be configured as an agitator propeller or similar and mix the heat exchanger fluid 15 by means of its own actively driven movement. It is possible to arrange such a circulation device 49, for example, on the bottom wall 32, as shown in FIG. 7, and/or on the tank side wall 34, as shown in FIG. 12, for example. For example, a drive motor not shown in detail in the figures, in particular an electric motor, may be provided to drive the circulation device 49.

In addition or as an alternative to the, in particular actively driven, circulation device 49, one or more passive turbulence generation devices 50 or static mixers may also be provided in the storage space 14. These are, for example, devices that represent flow obstacles for the heat exchanger fluid 15 within the storage space 14, such as baffle plates and/or perforated plates or the like. Such devices can promote mixing of the heat exchanger fluid 15, in particular when vibrations from outside act on the heat exchanger fluid tank 13 and thus on the heat exchanger fluid 15, as may occur, for example, during operation of the ground compaction machine 1.

It may be advantageous if measures are taken that enable heat to be effectively withdrawn from and/or supplied to the heat exchanger fluid 15 from outside the heat exchanger fluid tank 13 without heat exchanger fluid 15 having to be continuously removed from the storage space 14 and supplied again elsewhere. One way of achieving this may be cooling fins or the like attached to the external surface or the tank outer wall 24. Additionally or alternatively, however, it is also possible to provide one or more fin-like protrusions 54 in the storage space 14 in order to increase the external surface area of the storage space 14 in a compact manner. In this way, a larger outer surface area is available, via which heat from the heat exchanger fluid 15 can be dissipated through the tank wall to the outside environment 11.

Additionally or alternatively, a temperature control device 55, as shown in FIG. 15, for example, may also be included in the heat exchanger fluid tank 13. In the present case, the temperature control device 55 refers to a device with which thermal energy can be supplied to or withdrawn from the heat exchanger fluid 15 stored within the storage space 14 without requiring parts of the heat exchanger fluid 15 to be replaced. The temperature control device may therefore be, for example, a heating coil and/or a cooling finger or similar.

Even if it is possible that the volume of heat exchanger fluid 15 stored within the storage space 14 is a self-contained volume of heat exchanger fluid during operation of the ground compaction machine 1, it is also possible that heat exchanger fluid 15 is drained during operation of the ground compaction machine to supply a sprinkling device 56. This is illustrated in more detail, for example, in FIG. 15. According to FIG. 15, the heat exchanger fluid tank 13 is connected to one or more sprinkler outlets 58 in a fluid-conducting manner via a pipe system 57. With the aid of one or more of these sprinkler outlets 58, for example, the ground contacting device 6 of the ground compaction machine 1 can be sprinkled with heat exchanger fluid 15 during ongoing compaction operation to reduce dust formation and/or to prevent ground material from adhering to the ground contacting device 6 and/or to cool the ground contacting device 6. In this case, the heat exchanger fluid tank 13 may include a fluid outlet 59, for example in the form of a stopcock or other valve, by means of which a discharge of heat exchanger fluid 15 from the storage space 14 can be allowed, blocked and/or dosed via the line system 57. The sprinkling device 56 illustrated by way of example in FIG. 15 may also be present in a constructive and/or functional manner for each of the embodiments shown in the figures, which is not shown separately in each figure for reasons of clarity.

The heat exchanger fluid tank 13 may additionally or alternatively include one or more filling openings 60, one or more drain openings 61 and/or one or more venting/ventilation openings 62, as shown for example in FIG. 6.

To fill the storage space 14 with heat exchanger fluid 15, the receiving opening 23 may be used, if present. However, it is also possible that a dedicated filling opening 60 for filling the storage space 14 with heat exchanger fluid 15 is provided additionally or alternatively. This filling opening 60, which can ideally be closed by means of a closure element, is preferably arranged on an upper side 63 of the electrical operating component 8.

For transporting and/or storing the ground compaction machine 1, it may be advantageous if the heat exchanger fluid 15 stored within the storage space 14 can be removed from the heat exchanger fluid tank 13. For this purpose, the heat exchanger fluid tank 13 may have one or more drain openings 61. For example, the fluid outlet 59 described above may also be used to completely drain the heat exchanger fluid 15 from the storage space 14. Additionally or alternatively, however, the heat exchanger fluid tank 15 may also comprise a drain opening 61, preferably in the bottom wall 30, which is provided exclusively for draining the heat exchanger fluid 15, as shown, for example, in FIG. 6.

When inserting and/or removing the electrical operating components into/from the heat exchanger fluid tank 13, an overpressure and/or under pressure may occur inside the heat exchanger fluid tank 13. Furthermore, when the heat exchanger fluid 15 is heated within the storage space 14, the internal pressure within the heat exchanger fluid tank 13 may increase (or decrease during cooling). For pressure balance relative to the outside environment 41, the heat exchanger fluid tank 13 may therefore comprise one or more venting/ventilation openings 62, which in particular enable air exchange with the outside environment 41. The one or more venting/ventilation openings 62 are preferably arranged on the upper side 63 of the electrical operating component 8, as illustrated, for example, in FIG. 6.

In particular, the electrical operating component 8 may be part of an electrical drive system and, for this purpose, may be connected to one or more other electrical operating components 8 of the ground compaction machine 1 via one or more current-conducting and/or signal-conducting connections 65. To establish a current-and/or signal-conducting connection, the electrical operating component 8 may have a connection port 64. This port may be a plug contact or the like, for example. Although preferably comprised in all electrical operating components 8 shown in the embodiment examples, the connection port 64 and the current-conducting connection 65 are not shown in all embodiment examples for reasons of clarity.

As illustrated, for example, in the embodiment example according to FIG. 7, the connection port 64 may be arranged on a side 66 or in a region of the electrical operating component 8 that is above the fill level 27 of the heat exchanger fluid 15 in the vertical direction. In particular, this side may be an upper side 67 of the electrical operating components 8. The electrical operating component 8 may additionally or alternatively protrude in the vertical direction 84 beyond the upper side of the heat exchanger fluid tank 13.

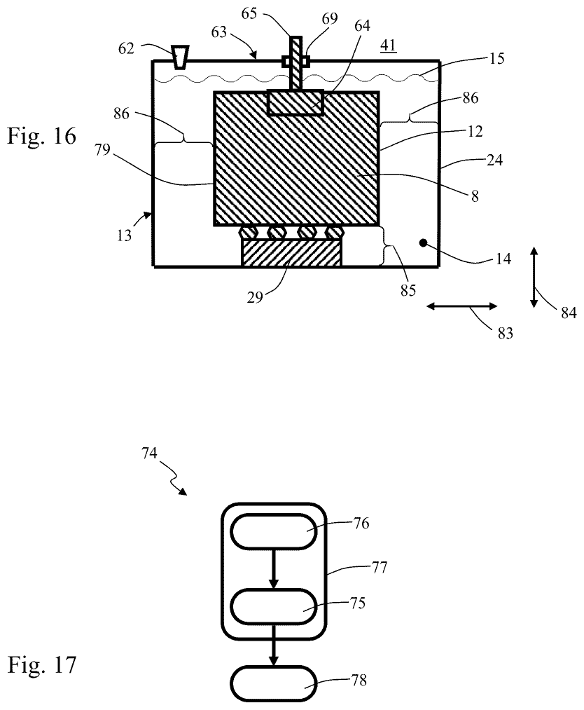

Additionally or alternatively, the connection port 64 may also be arranged in a region of the electrical operating component 8 that is wet by the heat exchanger fluid 15. This region of the outer surface 79 of the electrical operating component 8 is also referred to as the wetting region 68 (FIG. 15). In this regard, the embodiment example according to FIG. 16 shows a connection port 64 which, together with the electrical operating component, is completely wet on its outside by the heat exchanger fluid 15, i.e., immersed therein.

The heat exchanger fluid tank 15 may have one or more cable bushings 69 (FIG. 16), through which one or more current-conducting and/or signal-conducting connections 65 can be routed, which may, for example, connect a connection port 64 positioned inside the heat exchanger fluid tank 13 to one or more electrical operating components 8 located outside the heat exchanger fluid tank 15.

The heat exchanger fluid tank 13 may comprise one or more sensors and/or at least be connected to them. An example of this is illustrated in more detail in the embodiment example of FIG. 14.

For example, a fill level sensor 70 may be provided, which is configured to detect a fill level 27/27′of the heat exchanger fluid 15 within the storage space 14. For example, the fill level sensor 70 may be configured and arranged such that it detects when the fill level falls below and/or exceeds a lower and/or upper level limit value and/or determines a current fill level of the heat exchanger fluid 15 within a fill level range. The fill level sensor 70 may additionally or alternatively be configured such that it determines a sufficient fill level with and without the electrical operating component 8 inserted in the heat exchanger fluid tank 13.

Additionally or alternatively, one or more temperature sensors 71 may be provided, which are configured to detect an actual temperature of the heat exchanger fluid 15. In addition, one or more temperature sensors may also be provided, for example, which determine a current actual temperature of the electrical operating component 8 and/or the outside environment 41.

The one or more sensors, in particular the fill level sensor 70 and/or the temperature sensor 71, may be in signal transmission connection with a control unit 72 (FIG. 14). The control unit may control one or more machine functions of the ground compaction machine 1 depending on one or more of these sensor values. If, for example, the actual temperature of the heat exchanger fluid 15 exceeds a defined temperature threshold value, the control unit 72 may restrict or stop the operation of the ground compaction machine 1, as sufficient conductive heat energy transfer from the electrical operating component 8 to the heat exchanger fluid 15 is no longer guaranteed due to the comparatively high actual temperature of the heat exchanger fluid 15. In this case, the control unit 72 can thus intervene in the machine control of the ground compaction machine 1.

Additionally or alternatively, a display device 73 (FIG. 14), controlled in particular by the control unit 72, may also be provided. The display device can be used, for example, to display operating data of the ground compaction machine 1 and/or sensor data, in particular of the fill level sensor 70 and/or the temperature sensor 71, and/or at least information derived therefrom, etc.

FIG. 17 illustrates steps of a method 74 for operating a ground compaction machine 1, in particular a ground compaction machine 1 as described above. The method 74 is thus also provided in particular for implementation with a ground compaction machine 1 with a machine frame 2, a ground contacting device 6 mounted movably on the machine frame 2, a vibration excitation device 7, which sets the ground contacting device 6 in a vibrating and/or tamping motion in a compaction operation, and an electrical operating component 8 comprising a housing 12, as described, for example, with respect to the preceding embodiment examples.

The method 74 comprises transmitting 75 heat between the heat exchanger fluid 15 and the electrical operating component 8 within a heat exchange fluid tank 13 in a conductive manner. The electrical operating component 8 may be arranged within the heat exchanger fluid tank 13 such that the heat exchanger fluid 15 directly wets the housing 12 of the electrical operating component 8, so that heat can be transferred from the housing 12 directly into the heat exchanger fluid 15 and vice versa.

For the method 74 according to the invention, during operation of the ground compaction machine, no exchange of heat exchanger fluid of the heat exchanger fluid tank out of the storage space and/or into the storage space is provided for cooling and/or heating purposes, i.e., no addition of heat exchanger fluid 15 from outside the storage space 14 takes place. The entire heat exchanger fluid volume is thus completely stored 77 or held by the heat exchanger fluid tank 13.

However, during operation of the ground compaction machine 1, heat exchanger fluid 15 stored in the storage space 14 may be consumed 78, for example by successive draining of the heat exchanger fluid 15 via a sprinkling device 56.

### LIST OF REFERENCE NUMERALS

1 ground compaction machine
1A vibratory rammer
1B vibratory plate compactor
1C trench roller
1D roller
2 machine frame
3 manual guide device
4 vibration damping elements
5 substructure
6 substructure
7 vibration excitation device
8 electrical operating component
9 electrical energy storage device
10 power converter
11 electric motor
12 housing
13 heat exchanger fluid tank
14 storage space
15 heat exchanger fluid
16 heat exchange surface
17 cooling air device
18 vibration damping elements
19 vibration damping elements
20 front carriage
21 rear carriage
22 articulated joint device
23 receiving opening
24 tank outer wall
25 tank inner wall
26 receiving space
27 fill level
28 contact membrane
29 support elements
30 bottom wall
31 distance
32 bottom wall
33 lateral guide elements
34 tank side wall
35 combined stabilizing elements
36 entry slope
37 vibration damping elements
38 intermediate space
39 sealing element
40 contact collar
41 outside environment
42 lid
43 connecting joint
44 adapter lid
45 lid body
46 adapter piece
47 contact region
48 component generating heat during operation of the ground compaction machine
49 circulation device
50 passive turbulence generation device
51 fixing device
52 body
53 contact pressure element
54 protrusion
55 temperature control device
56 sprinkling device
57 line system
58 sprinkler outlet
59 fluid outlet
60 filling opening
61 drain opening
62 venting/ventilation opening
63 upper side
64 connection port
65 current-and/or signal-conducting connection
66 side of the electrical operating component above the heat exchanger fluid
67 upper side
68 wetting region
69 cable bushing
70 fill level sensor
71 temperature sensor
72 control unit
73 display device
74 method of operating a ground compaction machine
75 conductive transmission
76 directly wet
77 storage
78 consumption of heat exchanger fluid
79 housing outer surface
80 heat exchanger fluid tank inner surface
81 sealing region
82 energy storage elements
83 horizontal direction
84 vertical direction
85 horizontal distance
A forward direction

What is claimed is:

1. A ground compaction machine comprising:
a machine frame;
a ground contacting device mounted movably on the machine frame;
a vibration excitation device which sets the ground contacting device in a vibrating and/or tamping motion in a compaction operation; and
an electrical operating component comprising a housing, wherein:
it has a heat exchanger fluid tank with a storage space filled with a heat exchanger fluid, and in that a heat exchange surface is provided within the heat exchanger fluid tank, via which heat energy can be exchanged between the electrical operating component and the heat exchanger fluid located within the storage space; and
it has a sprinkling device with a fluid outlet, and in that the fluid outlet is connected in a fluid-conducting manner to the heat exchanger fluid tank such that, during operation of the ground compaction machine, heat exchanger fluid contained in the heat exchanger fluid tank can discharge via the fluid outlet of the sprinkling device.

2. The ground compaction machine according to claim 1, wherein the heat exchanger fluid tank has a receiving opening located at a top in a vertical direction, and in that the electrical operating component projects through the receiving opening into the storage space filled with heat exchanger fluid.

3. The ground compaction machine according to claim 1, wherein the heat exchanger fluid tank has, within the storage space, a contact membrane forming at least part of the heat exchange surface and made of a flexible and fluid-tight material, and in that the contact membrane separates a receiving space for the electrical operating component within the heat exchanger fluid tank from the storage space which receives the heat exchanger fluid within the heat exchanger fluid tank.

4. The ground compaction machine according to claim 1, wherein the housing of the electrical operating component is wet directly with the heat exchanger fluid inside the heat exchanger fluid tank, and in that the housing of the electrical operating component forms the heat exchange surface.

5. The ground compaction machine according to claim 1, wherein one or more lateral guide elements are provided, in particular within the storage space, which are configured to align the electrical operating component relative to the heat exchanger fluid tank in a horizontal direction.

6. The ground compaction machine according to claim 1, wherein one or more support elements are provided, in particular within the storage space, on which the electrical operating component stands within the heat exchanger fluid tank.

7. The ground compaction machine according to claim 1, wherein a fixing device is provided which fixes the electrical operating component relative to the heat exchanger fluid tank.

8. The ground compaction machine according to claim 1, wherein the housing of the electrical operating component has a contact collar, in particular extending circumferentially, which contacts the heat exchanger fluid tank and/or rests on the heat exchanger fluid tank.

9. The ground compaction machine according to claim 1, wherein the distance between the outer surface of the housing of the electrical operating component and the inner surface of the heat exchanger fluid tank, in particular in a horizontal plane, is at least 5 mm, in particular at least 10 mm.

10. The ground compaction machine according to claim 1, wherein one or more sealing elements are provided, which seal the storage space of the heat exchanger fluid tank towards the outside environment, in particular in a sealing region between the heat exchanger fluid tank and the electrical operating component.

11. The ground compaction machine according to claim 1, wherein the electrical operating component comprises a connection port for obtaining a current-conducting connection, the connection port being positioned:
on an upper side of the electrical operating component; and/or
on one side of the electrical operating component which is located in a region of the electrical operating component not wet by the heat exchanger fluid.

12. The ground compaction machine according to claim 1, wherein the heat exchanger fluid tank comprises a body forming the storage space and a lid closing the storage space towards the outside environment.

13. The ground compaction machine according to claim 12, wherein a connecting joint is provided between the body and the lid, and that the lid is adjustable relative to the body about the connecting joint.

14. The ground compaction machine according to claim 1, wherein the heat exchanger fluid tank is made of a plastic material.

15. The ground compaction machine according to claim 1, wherein one or more vibration damping elements are provided, which dampen vibration transmission between the electrical operating component and the heat exchanger fluid tank.

16. The ground compaction machine according to claim 1, wherein the heat exchanger fluid tank is connected to the machine frame via one or more vibration damping elements.

17. The ground compaction machine according to claim 1, wherein the heat exchanger fluid tank has a contact region on its outer surface, and in that a component which generates heat during operation of the ground compaction machine is in direct contact with this contact region.

18. The ground compaction machine according to claim 1, wherein a circulation device and/or a passive turbulence generation device is provided within the heat exchanger fluid tank.

19. The ground compaction machine according to claim 1, wherein the storage space of the heat exchanger fluid tank is closed during operation of the ground compaction machine such that the heat exchanger fluid volume located within the storage space remains unchanged.

20. The ground compaction machine according to claim 1, wherein the heat exchanger fluid tank comprises a filling opening and/or a drain opening and/or a venting/ventilation opening.

21. The ground compaction machine according to claim 1, wherein it comprises an electric motor, and in that the electric motor is arranged in front of the heat exchanger fluid tank in a forward direction of the ground compaction machine.

22. The ground compaction machine according to claim 1, wherein it comprises a fill level sensor for determining a fill level of the heat exchanger fluid within the heat exchanger fluid tank and/or a temperature sensor for determining a temperature of the heat exchanger fluid within the heat exchanger fluid tank.

23. The ground compaction machine according to claim 1, wherein a temperature control device for cooling and/or heating the heat exchanger fluid is provided in the heat exchanger fluid tank, the temperature control device being configured such that cooling and/or heating of the heat exchanger fluid takes place without simultaneous withdrawal and/or supply of the heat exchanger fluid into the heat exchanger fluid tank.

24. The ground compaction machine according to claim 1, wherein the electrical operating component is:
an electrical energy storage device with one or more energy storage elements;
a power converter; and/or
an electric motor.

25. The ground compaction machine according to claim 1, wherein the ground compaction machine is a vibratory rammer, a vibratory plate compactor, a trench roller or a roller.

26. A method for operating a ground compaction machine according to claim 1, the ground compaction machine comprising:
a machine frame;
a ground contacting device mounted movably on the machine frame;
a vibration excitation device which sets the ground contacting device in a vibrating and/or tamping motion in a compaction operation; and
an electrical operating component comprising a housing,
the method comprising transmitting heat between the heat exchanger fluid and the electrical operating component within a heat exchanger fluid tank in a conductive manner and, in operation of the ground compaction machine, consuming heat exchanger fluid by a sprinkling device.

27. The method according to claim 26, wherein the electrical operating component is arranged within the heat exchanger fluid tank such that the heat exchanger fluid directly wets the housing of the electrical operating component, so that heat is transferred from the housing directly into the heat exchanger fluid.

28. The method according to claim 26, comprising completely storing heat exchanger fluid of the heat exchanger fluid tank in the storage space during operation of the ground compaction machine.
